(19) United States
(12) Patent Application Publication
(10) Pub. No.: US 2009/0106208 A1
(43) Pub. Date: Apr. 23, 2009

(54) APPARATUS AND METHOD FOR CONTENT ITEM ANNOTATION

(75) Inventors: Adrian Matellanes, Hampshire (GB); Paola M. Hobson, Hants (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/299,161

(22) PCT Filed: May 21, 2007
(86) PCT No.: PCT/US07/69342

§ 371 Date: Oct. 31, 2008

(30) Foreign Application Priority Data
Jun. 15, 2006 (GB) 0611943.2

(51) Int. Cl. G06F 7/06; G06F 17/30

(52) U.S. Cl. 707/3; 707/100; 707/E17.044; 707/E17.014

(57) ABSTRACT

An apparatus for content item annotation comprises an ontology processor (103) which generates a reduced ontology from a first ontology. The reduced ontology comprises a subset of concepts of the first ontology. An analysis processor (107) and an annotation processor (109) determine first annotation data for the content item by content analysis based on the reduced ontology. A monitoring processor (115) monitors usage of the first annotation data. A criterion processor (117) determines if the usage of the first annotation data meets a first criterion. If not, the ontology processor (103) generates a second ontology from the first ontology and the analysis processor (107) and the annotation processor (109) modifies the first annotation data in response to a content analysis based on the second ontology. The invention may allow a facilitated automatic annotation of content items with more efficient usage of the computational resource available for the annotation.

### FIELD OF THE INVENTION

The invention relates to an apparatus and method for content item annotation and in particular, but not exclusively to automatic annotation of visual content items such as digital images or video sequences.

### BACKGROUND OF THE INVENTION

In recent years, the availability and provision of multimedia and entertainment content has increased substantially. For example, the number of available television and radio channels has grown considerably and the popularity of the Internet has provided new content distribution means. In addition, the increased digitalisation and ways of encoding content has led to an increased distribution of many different types of content items including digital pictures, music, audio clips, video clips etc.

Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content. In order to facilitate content item management, searching and processing, it is common practice to annotate content items by creating data indicative of the content and associating it with the content.

For example, the sale of multimedia assets such as video clips and images depends on the user being able to find them via search engines. The success of searching often depends on the availability of suitable data describing the content. However, a problem faced by many content owners is that they have large archives of legacy content which has never been annotated, or have only been provided with insufficient annotation.

Annotation of content items is often performed manually where a person reviews the content items and selects or generates suitable data. However, this approach is very cumbersome, time consuming and resource intensive and is not practical for large content item collections.

In order to address this, methods for automatic annotation of content items have been proposed. Specifically, automatic content analysis may be performed which identifies specific objects or characteristics of content items and generates data for the content to reflect the identified characteristics. An example of such automatic annotation systems can be found in for example United States Patent Applications US 2005/0114325 which describes generation of data from an automated analysis of images or US 2005/00071865 which describe a system wherein data for digital content can be automatically generated and then modified by a user. Other examples of automatic annotation is provided in the aceMedia annual public report for 2005 e.g. available from http://www.acemedia.org/aceMedia/files/document/aceMedia-Annual-public-report-2005.pdf and “Knowledge-Assisted Video Analysis Using a Genetic Algorithm”, N. Voisine, S. Dasiopoulou, V. Mezaris, E. Spyrou, T. Athanasiadis, I. Kompatsiaris, Y. Avrithis, M. G. Strintzis, Workshop on Image Analysis for Multimedia Interactive Services (WIAMIS 2005), Montreux, Switzerland, Apr. 13-15, 2005.

However, a problem with current approaches is that they tend to generate suboptimal annotations and/or to be time consuming and resource demanding. For example, for the aceMedia system described above, annotation of a 0.5 megapixel image on a Personal Computer currently takes around two minutes (for a Pentium P4 2.8 GHz system with around 500 MB of memory).

This is highly impractical in many scenarios. For example, a content owner with large archives of un-annotated content items would have to endure a prohibitively long delay before all content items are annotated. Furthermore, the described approaches tend to generate large amounts of data for each content item which further complicates searching, storage and distribution.

Hence, an improved system of annotation of content items would be advantageous and in particular a system allowing increased flexibility, improved user experience, facilitated searching, reduced complexity, improved annotations, reduced resource demands, reduced processing times and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for content item annotation, the apparatus comprising: means for generating a reduced ontology from a first ontology, the reduced ontology comprising a subset of concepts of the first ontology; means for determining first annotation data for the content item by content analysis based on the reduced ontology; monitoring means for monitoring usage of the first annotation data; criterion means for determining if the usage of the first annotation data meets a first criterion; modifying means for, if the usage of the first annotation data does not meet the first criterion, generating a second ontology from the first ontology and modifying the first annotation data in response to a content analysis based on the second ontology.

The invention allows for improved and/or facilitated content item annotation. The invention may in particular allow a content annotation which is gradually and automatically refined to a level sufficient for the usage of the annotation information. The invention may reduce the amount of data being generated for a content item to a sufficient level and may in particular eliminate or alleviate the need for a full analysis. The invention may allow a reduced processing time and resource requirement for annotating a content item.

The invention may allow an automated adaptation of annotation(s) of content item(s) to the specific characteristics and environment of the system in which they are used. Specifically, the content item annotation may be limited to a reduced annotation unless a full annotation is required. The adaptation to the specific requirements may be achieved automatically and without any user involvement.

The second ontology may comprise more concepts than the reduced ontology and/or may be a combined ontology comprising a plurality of different domain ontologies.

The apparatus may be arranged to iterate the process of monitoring usage of the first annotation data; determining if the usage of the first annotation data meets a first criterion; and, if the usage of the first annotation data does not meet the first criterion, generating a new ontology from the first ontology and modifying the first annotation data in response to a content analysis based on the new ontology. Each new ontology may correspond to a larger subset of the first ontology, e.g. with an increased number of concepts included.

The annotation data may be any kind of data describing a content item. For example, the annotation data can be metadata (data about data) and/or can e.g. include free text terms and numerical data.

According to an optional feature of the invention, the means for generating the reduced ontology is furthermore arranged to generate first content description data for the subset of concepts and wherein the content analysis is in response to the first content description data.

This may allow improved and/or facilitated content analysis which is targeted to the characteristics of the reduced ontology and may allow improved annotation and/or may allow a reduced processing time and resource requirement for annotating a content item. The first content description data may specifically be description data for prototypical instances of concepts of the reduced ontology.

According to an optional feature of the invention, the modifying means is arranged to generate second content description data for concepts of the second ontology and wherein the content analysis based on the second ontology is further in response to the second content description data.

This may allow improved and/or facilitated content analysis which is targeted to the characteristics of the second ontology and may allow improved annotation and/or may allow a reduced processing time and resource requirement for annotating a content item. The second content description data may specifically be description data for prototypical instances of concepts of the second ontology.

According to an optional feature of the invention, the apparatus further comprises: means for storing a plurality of annotated content items; means for searching the plurality of content items in response to search data based on the first ontology; and means for identifying the first content item in response to a match between the search data and the first annotation data.

The means for identifying may be arranged to determine that the search data matches the first annotation data in response to a match criterion. Any suitable match criterion may be used. The invention may allow a search system for content items which is based on annotated content items while limiting the resource required by such search and/or annotation processes.

According to an optional feature of the invention, the first criterion includes an evaluation of a number of times the first content item is identified in response to a search.

Such a criterion may in many embodiments provide a particularly advantageous criterion for adapting the annotation behaviour to the specific requirements for the system.

According to an optional feature of the invention, the first criterion includes an evaluation of a number of other content items identified by a search identifying the first content item.

Such a criterion may in many embodiments provide a particularly advantageous criterion for adapting the annotation behaviour to the specific requirements for the system.

According to an optional feature of the invention, the means for identifying the first content item is arranged to generate a match indication of how closely the first content item matches the search data; and the first criterion includes an evaluation of the match indication.

Such a criterion may in many embodiments provide a particularly advantageous criterion for adapting the annotation behaviour to the specific requirements for the system.

According to an optional feature of the invention, the apparatus further comprises means for presenting an indication of content items identified by the search to a user of the apparatus; means for receiving a user selection of at least one of the content items; and wherein the first criterion includes an evaluation of a number of times the first content item is selected by the user.

Such a criterion may in many embodiments provide a particularly advantageous criterion for adapting the annotation behaviour to the specific requirements for the system. In particular, it may allow an efficient adaptation to the user preferences while maintaining a user friendly experience.

According to an optional feature of the invention, the apparatus further comprises means for determining an annotation indication of a level of annotation for the plurality of content items and wherein the first criterion includes an evaluation of the annotation indication.

Such a criterion may in many embodiments provide a particularly advantageous criterion for adapting the annotation behaviour to the specific requirements for the system.

According to an optional feature of the invention, the apparatus further comprises means for selecting concepts from the subset of concepts of the reduced ontology in response to a user input.

This may allow for improved and/or facilitated content item annotation. In particular it may allow an improved adaptation of the first annotation data thereby reducing the probability of further annotations being necessary.

According to an optional feature of the invention, the apparatus further comprises means for selecting concepts from the subset of concepts of the reduced ontology in response to a use frequency of concepts of the first ontology.

This may allow for improved and/or facilitated content item annotation. In particular it may allow an improved adaptation of the first annotation data thereby reducing the probability of further annotations being necessary.

According to another aspect of the invention, there is provided a method of content item annotation, the method comprising: generating a reduced ontology from a first ontology, the reduced ontology comprising a subset of concepts of the first ontology; determining first annotation data for the content item by content analysis based on the reduced ontology; monitoring usage of the first annotation data; determining if the usage of the first annotation data meets a first criterion; and if the usage of the first annotation data does not meet the first criterion, generating a second ontology from the first ontology and modifying the first annotation data in response to a content analysis based on the second ontology.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a content item server in accordance with some embodiments of the invention; and

FIG. 2 is an illustration of a method for content item annotation in accordance with some embodiments of the invention.

### DETAILED DESCRIPTION OF SOME EMBODIMENTS OF THE INVENTION

The following description focuses on embodiments of the invention applicable to semantic annotation and searching of visual content items such as pictures or video clips. Furthermore, in the described examples, the annotation may be performed fully automatically. However, it will be appreciated that the invention is not limited to this application.

The described systems for annotation employ a two (or more)-stage annotation process. Initially a content analysis and annotation of one or more content items is performed based on a reduced ontology and a reduced set of content descriptors. This allows a fast and low resource annotation and leads to a small data set. Subsequently, when the data is used (e.g. by searching or other end user operations) the usage is monitored and the system determines whether or not the data set is adequate based on the usage. If it is determined that the annotation is not sufficient in accordance with a suitable criterion, the content analysis and annotation is repeated using an expanded ontology and a larger set of content descriptors. This may provide additional and more accurate annotations but may also take longer and be more resource intensive. However, the additional time and resource is only expended when specifically necessary. This process may be iterated a number of times and may specifically be continuously iterated. Thus, a full feedback loop can be implemented which continues to modify the ontology, perform an analysis, annotate the content items, monitor the usage, expand the ontology used for annotating, re-analyse using the new ontology, add data to the annotation, monitor the usage again, expand the ontology again etc. Thus, the approach may allow a gradual and targeted refinement of the annotations of a collection of content items where the resource in providing additional data is targeted at the content items and ontologies where it is most needed.

The content analysis and annotation is based on use of ontologies for the content item being annotated. An ontology is a shared understanding of some domain of interest. In particular, an ontology provides a reference frame and definition for various concepts and the relationships between them, which may be a general representation of knowledge, and may also be specific to a particular domain. A concept within an ontology can be a physical (concrete) object of the domain (the sea in the domain of beach images) or an abstract object (the weather in the domain of beach images). Concepts are represented by instances of the concept. A number of different properties (parameters and characteristics) of a given concept may be represented in an ontology. Thus, for a defined ontology which is shared between applications and web services, the different applications and web services may exchange information relating to characteristics of objects (concrete or abstract) by using the defined ontology. This allows web services and applications to accurately and effectively exchange information without requiring the objects to be predefined at the time of the design of the web services and applications. Thus ontologies are used for sharing a consistent understanding of what information means and also allow knowledge re-use as a common reference for different web services and applications.

In the specific example, ontology driven analysis leading to data about the content may be generated by the automatic annotation and user applications may specify e.g. search data in terms of the ontology thereby facilitating the interfacing between user applications and the system.

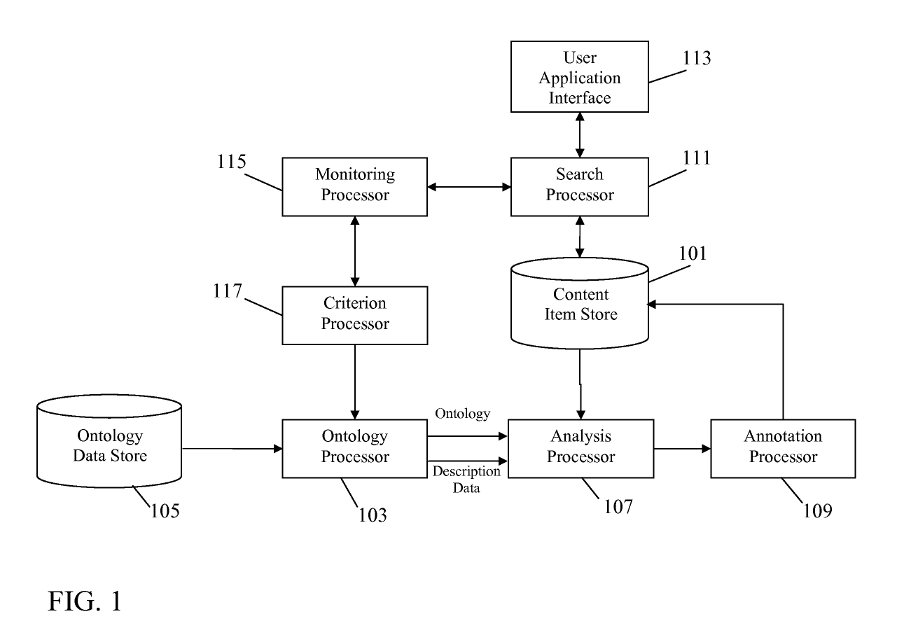

FIG. 1 illustrates an example of a content item server in accordance with some embodiments of the invention. The content item server comprises functionality for automatically and adaptively annotating content items as well as for searching for content items using the annotations. The annotation and searching operations are ontology based.

Specifically, the content item server comprises a content item store 101 which stores a large number of content items and which in the specific example stores a large number of video clips and digital images. The following description will focus on a scenario where none of the content items are initially annotated but it will be appreciated that the described principles apply equally well to scenarios where some or all of the content items have some annotations. For example, the described annotation process may only be applied to new content items which are received without any or insufficient annotations.

The content item server furthermore comprises an ontology processor 103 which is coupled to an ontology data store 105. The ontology data store 105 comprises one or more ontologies for content items. In the example, the ontology data store 105 comprises a number of ontologies associated with different visual domains. For example, the ontology data store 105 can comprise an ontology for beach images or video clips, an ontology for tennis images or video clips, an ontology for a facial images or video clips etc. each of the ontologies comprises a definition of a number of general concepts relating to images and video (such as visual features, spatial and temporal concepts) as well as core concepts which are applicable to a range of natural and artificial domains (such as geographical features, built environment objects, and plants/animals). There will also be stored concepts associated with the domain of the ontology as well as relationships between the concepts. For example, the beach ontology can define a data structure including concepts such as sea, sand, sky, sun, weather, people, roads, cars etc. and relationships between them such as sand “ispartof” beach, for example.

Furthermore, in the example, the ontology data store 105 also comprises content description data associated with instances of the concepts defined by the ontologies. Specifically, for at least some of the concepts of an ontology, the ontology data store 105 comprises data describing characteristics and properties associated with prototypical image objects belonging to the different concepts. For example, for the sea concept of the beach ontology, content description data describing prototypical colours and textures for images of the sea can be stored.

The ontology processor 103 is coupled to an analysis processor 107 which is further coupled to an annotation processor 109. The analysis processor 107 and the annotation processor 109 are furthermore coupled to the content item store 101.

When the content item server initiates an automatic annotation of a content item, the ontology processor 107 retrieves an ontology from the ontology data store 105. The ontology may specifically be selected as an ontology corresponding to the content item e.g. based on initial information of the content of the content item. For example, it may be known that the image may potentially relate to a beach scenario and accordingly the beach ontology may be retrieved from the ontology data store 105. In other scenarios, the most suitable ontology may be determined based on a user input or may be based on an initial coarse content analysis. For example, prior to starting the annotation, a user may manually arrange the content items of the content item store 101 into domain groups (e.g. one directory may comprise beach images/video clips, another facial images/video clips etc).

In addition to retrieving the ontology, the ontology processor 103 also receives the content description data which has been stored for the prototypical instances defined within the ontology.

The ontology processor 103 proceeds to generate a reduced ontology which is initially used for the analysis and annotation of the content item. Specifically, the ontology processor 103 selects a subset of concepts from the first ontology and uses an ontology consisting of these concepts. For example, an ontology may typically comprise many tens of concepts and the ontology processor 103 may select, say, five of these concepts to drive the analysis for the initial annotation. Thus, instead of attempting to generate data for all the possible concepts of the ontology, the initial annotation will only try to generate data for a small subset of the concepts.

In addition, the ontology processor 103 selects a subset of the content description data. Specifically, the content description data which belong to the prototypical instances of the chosen concepts are selected.

The ontology processor 103 then feeds the reduced ontology and the selected content description data to the analysis processor 107.

The analysis processor 107 proceeds to perform content analysis based on the reduced ontology and the selected content description data.

As a simple example, the analysis processor 107 can attempt to identify picture objects that have characteristics similar to the characteristics indicated by the content item description data. E.g. if the prototypical instances from the reduced ontology include the concept “sea”, the content analysis can search a digital image to find a picture object meeting the received description data for a sea object (e.g. green/blue colour variations, below “sky”, above “ground” etc).

It will be appreciated that in practical systems, a much more complex and sophisticated content analysis will typically be used. Such analysis algorithms will be known to the person skilled in the art and any suitable content analysis approach can be used without detracting from the invention. An example of a more advanced content analysis that may be suitable for the content item server of FIG. 1 can be found in “Relating Visual And Semantic Image Descriptors” by J. Stauder, J. Sirot, H. Le Bogne, E. Cooke and N. E. O'Connor, European Workshop for the Integration of Knowledge, Semantics and Digital Media Technology, EWIMT 2004, London, UK, Nov. 25-26, 2004.

The result of the content analysis is fed to the annotation processor 109 which proceeds to generate semantic data for the content item based on the content analysis and the reduced ontology. Specifically, the annotation processor 109 can generate a data object structured in accordance with the reduced ontology (and thus can also be structured in accordance with the original full ontology). Thus a data object is generated which contains semantic data for one or more of the subset of concepts of the reduced ontology.

As a simple example, if the content analysis has recognised an image object corresponding to one of the concepts, the annotation processor 109 may include a data element in the structure describing the presence of this concept as well as further details of the object.

The annotation processor 109 then stores the annotation data object with the content item in the content item store 101 thereby making it available for various user applications.

As the content analysis and annotation is only performed for a small subset of the concepts of the underlying ontology for the content item, a substantial reduction in the resource requirement can be achieved. Specifically, a much faster annotation of a content item can be achieved. This provides a much reduced waiting time when annotating content items and specifically allows a practical annotation of large libraries of content items using relatively low computational resource. In the specific example, the content item server proceeds to annotate all the content items stored in the content item store 101 using reduced ontologies. It will be appreciated that the fundamental ontology used and/or the reduced ontology generated by the ontology processor 103 may be different for different content items.

The content item server is furthermore arranged to monitor the usage of the generated annotation data and can specifically monitor if any of the annotation data appear to be insufficient. In this case, another iteration of the content analysis and annotation is performed using a larger ontology than the initial reduced ontology thereby resulting in more (and/or more accurate) data being generated.

In the specific example, the content item server can receive search requests from external user applications and can identify content items in response to the searches. Specifically, the content item server comprises a search processor 111 which is coupled to the content item store 101 and a user application interface 113.

The user application interface 113 can receive search requests from user applications which may be external or internal to the content item server. For example the user application may be a simple user interface application which provides a manual interface to a user. The user can then explicitly enter a search string which is fed to the user application interface 113 through the user interface application. As another example, the user application can be a remote application that communicates with the user application interface 113 through a network such as for example the Internet. The remote user application may for example be a multimedia playing application.

The received search data will typically be structured in accordance with the ontology for the desired content item(s). However, in some embodiments the received search data from the user application can be converted from another data structure to a data structure matching the ontology by the user application interface 113.

The search processor 111 then proceeds to search through the annotation data which is stored in the content item store 101. Specifically the search processor 111 compares the individual specified concepts of the search data to the concepts of the data to find any content items that match. It will be appreciated that any suitable match criterion can be used for determining whether the annotation data for a content item matches the search data.

The search processor 111 provides an identification of the content items that match the search data to the user application interface 113 which then forwards this list to the user application. The user application can then request a specific content item from the content item server by selecting from the provided list and in response to the specific request the content item server can transmit the selected content item.

As the annotation is less rich than would be available had the full ontology been used to drive the analysis process, the search process is facilitated and can be performed faster. However, the reduced amount of data can also result in a less than optimal search accuracy. For example, the relatively few concepts may result in the search data matching a large number of content items thereby making the search impractical for the user. Furthermore, even providing more detailed search data may not necessarily improve the search accuracy as the searched annotation data may not be correspondingly detailed.

Accordingly, the content item server comprises a monitoring processor 115 which monitors the usage of the annotation data. In the specific example, the monitoring processor 115 monitors the search data and the search results to determine if the current data is sufficient to provide the desired service. Specifically the monitoring processor 115 can monitor the number of matches which are found for the individual searches.

The monitoring processor 115 is coupled to a criterion processor 117 which determines if the usage of the annotation data meets a given criterion. The criterion is selected to provide an assessment of whether the current annotation data is sufficient. It will be appreciated that the exact criterion which is used depends on the individual embodiment and requirements for the application as well as individual preferences.

As a simple example, the criterion processor 117 can determine whether searches provide a reasonable number of matches. For example, if too many matches are found, this indicates that the data is not sufficiently accurate to identify the most appropriate content items, and if too few matches are found this indicates that the data does not contain enough concepts to match enough searches.

The criterion processor 117 is coupled to the ontology processor 103. If the criterion processor 117 determines that the annotation data is not sufficient, it controls the ontology processor 103 to generate a second ontology. For a given content item, the second ontology is based on the same underlying ontology as the reduced ontology. However, in comparison to the reduced ontology, the second ontology is selected to result in more data being generated (e.g. the pruning of the originating ontology is less severe than in the first case). Specifically, the second ontology can correspond to the first ontology but with an added number of concepts selected from the fundamental originating ontology. E.g. if the first reduced ontology contained five concepts, the second ontology may be generated containing 15 concepts.

As another example, whereas the reduced ontology is typically based on a single domain ontology, the second ontology can additionally include concepts selected from another ontology. E.g. a second ontology for analysing a digital image may include concepts from both a beach domain ontology and a faces domain ontology.

In addition to the second ontology, the ontology processor 103 also retrieves additional content description data matching the prototypical instances within the expanded ontology. For example, the criterion processor 103 can retrieve the content description data for the prototypical additional concepts included in the second ontology.

The second ontology and the additional content description data are fed to the analysis processor 107 which proceeds to perform a new content analysis based on the content description data. The result is fed to the annotation processor 109 which proceeds to generate semantic data for the new concepts.

Specifically the annotation processor 109 can generate data relating to the new concepts and can add data to the annotation data object already stored for the content item. It will be appreciated that in some embodiments a new data object may be generated which may be used in addition to or instead of the original data object.

It will be appreciated that in some embodiments, the described operations are iterated a number of times and/or may be continuously iterated. For example, the monitoring processor 115 may continue to monitor the usage of the annotation data and whenever the criterion processor 117 determines that the annotation data for a content item (or group of content items) is insufficient, a new iteration may be initiated where the ontology processor 103 generates a new ontology which expands on the ontology of the previous iteration (e.g. by adding more concepts from the underlying ontology to the ontology of the previous iteration). The analysis processor 107 and annotation processor 109 then proceeds to generate annotation data based on the new expanded ontology thereby generating additional annotation data which can be added to the annotation data object(s) stored for the content item(s).

Thus, the content item server allows for a fast and low resource demanding initial annotation which provides reduced but frequently usable data. It furthermore allows an automatic improvement of the annotations which are not considered sufficient. The resource is thus automatically used in a targeted and adaptive approach which allows the resource to be used to improve performance where it is most needed.

The initial annotation can e.g. be monitored over a period which may be determined by the content owner. This may be a fixed time period (e.g. hours, days, weeks) or a number of uses of the content (e.g. 10, 100, 1000 uses). If the annotation is deemed to be sufficient (correct and complete) according to the applied criterion, then no further action is needed on the part of the system or content owner.

Furthermore, the content item server may continue to monitor the usage and may automatically continue to improve the content item annotations which are not sufficient. Thus, if the second update of the annotation data does not meet the criterion, another more expanded ontology can be generated and further annotation data can be generated using this ontology. The process of generating a new ontology, performing a content analysis and generating data can thus be continuously iterated until the criterion is met.

Furthermore, in some embodiments the criterion may be varied with time. For example, for the initial annotation and operation, a relatively relaxed criterion may be used. Subsequently, when all content items have been annotated to meet this criterion (and thus the computational resource used for annotating to this level is freed up), the criterion may be replaced or enhanced by a more stringent criterion which leads to further data being generated. Thus, a gradual improvement of the performance of the system can be achieved while allowing a fast initialisation to a given performance level.

It will be appreciated that any suitable criterion can be used by the criterion processor 117 to determine whether the annotation data is considered sufficient.

Specifically, the number of times a content item is identified in response to a search and/or the number of other content items which are identified by the searches identifying the first content item can be evaluated.

E.g. how often the image or video content has been presented to a user searching with a keyword and/or example region can be evaluated. No presentation as part of a large number of queries issued by the user means that the annotation is possibly imprecise or may even be erroneous and that a better annotation might help the image or video being found in some of the user queries. This is a negative response and would favour using the feedback loop to improve the annotation.

As another example, how often the image or video content has been presented to a user searching with a keyword and/or example region (for hybrid visual-semantic search) as part of a small set of candidate content (e.g. within the top 20 items returned) can be evaluated. Presentation as part of a small number of returned items indicates that the annotation was precise enough to be indicative of the image or video content.

Another example is to evaluate how often the image or video content has been presented to a user searching with a keyword and/or example region as part of a large set of candidate content (e.g. as one of 200 items returned). Presentation as part of a large number of returned items indicates that the annotation is possibly imprecise or may even be erroneous. This is a negative response and would favour using the feedback loop to improve the annotation.

Thus, the criterion can determine if the content item is found sufficiently frequently by search strings resulting in less than a given number of content items.

Alternatively or additionally, the criterion can evaluate how closely the first content item matches the search data. A rating of the search accuracy may be determined and used to evaluate if the annotation data are sufficient.

Alternatively or additionally, in embodiments where a user application can select a content item from the search results, the criterion can include an evaluation of a number of times the first content item is selected by the user application.

E.g. it can be evaluated how often the image or video content was accepted by the user within the set of candidate content offered to them, e.g. that the content was purchased or that it was selected within a relevance feedback based search. This is a positive response and would favour retaining the initial annotation. Similarly, it can be evaluated how often the image or video content was rejected by the user within the set of candidate content offered to them. This is a negative response and would favour using the feedback loop to improve the annotation.

Alternatively or additionally, the criterion can evaluate how often the content was used at all. If it is rarely ever selected, it could be of very limited attractiveness in the market, and would not warrant any further annotation.

Alternatively or additionally, the criterion can evaluate an annotation indication of a level of data annotation for the annotated content items and the criterion can include an evaluation of the annotation indication. Specifically, the criterion can evaluate how dense the annotations of the image or video are in the content item store 101. If the image or video has annotations that are part of a big subset of images and videos with the same annotations, then that is a negative response and would favour using the feedback loop to improve the annotation.

The evaluations may be applied in a simple manner e.g. after the chosen time period, if more positive indications than negative indications have been found, then no further annotation is needed (the evaluation may be repeated periodically). Alternatively or additionally, a threshold can be applied such that if a chosen number of negative responses have occurred, a further annotation is performed.

The initial concepts which are selected for the reduced ontology may be concepts which are predetermined and/or are selected manually by a user. However, in some embodiments, the selection of concepts for the reduced ontology and/or for subsequent ontologies may be based on the system usage i.e. a history of concepts used in searches can be built up and the most frequently used concepts can be identified as priority concepts which are selected for the ontologies in preference to other concepts not occurring as frequently.

As an example of the operation of the described system, a tennis domain ontology may e.g. contain 64 concepts, with a large number of relations between them (this is a relatively simple ontology—other ontologies may contain many more concepts and relations). However, users tend to search for specific players, venues and actions when looking for tennis footage, and the appearance in a scene of e.g. a particular umpire or ball boy is generally less relevant. Thus, by initially reducing the domain ontology to focus on 6-8 concepts, a substantial reduction in processing time can be achieved while still providing searches that will satisfy the users.

As another example, simulations have been performed for the automatic annotation of a database with more than 100 pictures. The annotation was performed according to a Trekking domain ontology. For simplicity, the simulation focused on three concepts within this ontology, “OUTDOOR”, “MOUNTAIN” and “SNOW” with the following relations between them:

SNOW—covers—>MOUNTAIN—is subclass of—>OUTDOOR

Step 1. Initial annotation. The database comprised many pictures (around 65) which initially were annotated only with the OUTDOOR keyword. This clearly provides little information to select between images when a semantic search is performed. Specifically, searches run for “mountain covered with snow” would return either no results (because no picture is annotated to that level of detail) or all pictures annotated with “OUTDOOR” (because the system finds that the most similar annotations are “outdoor”, of which “mountain” is a subclass).

Step 2. First Annotation Iteration. As part of the first iteration, the concept “MOUNTAIN” was added to the ontology. A subset of the images was annotated with the concept “MOUNTAIN”. The query still returned too many results, 18 (not a big number but a high percentage of the database), meaning that their characterization was considered insufficient.

Step 3. Second Annotation Iteration. In the second iteration the concept “SNOW” was included, which is related to “MOUNTAIN” through the “IS_COVERED_WITH” relation. This time, only 3 pictures were annotated with that concept and returned when the query was issued. The annotations are considered sufficiently precise to allow desired content to be found and no further iterations were performed.

The described approach thus uses a feedback loop process for image and video content self-annotation incorporating run-time user definable rules for determination of whether to repeat/improve analysis or accept the current annotation as adequate. This allows the use of automatic semantic annotation of e.g. video and image content in a highly efficient way, which makes the use of such tools realistic for owners of large content collections.

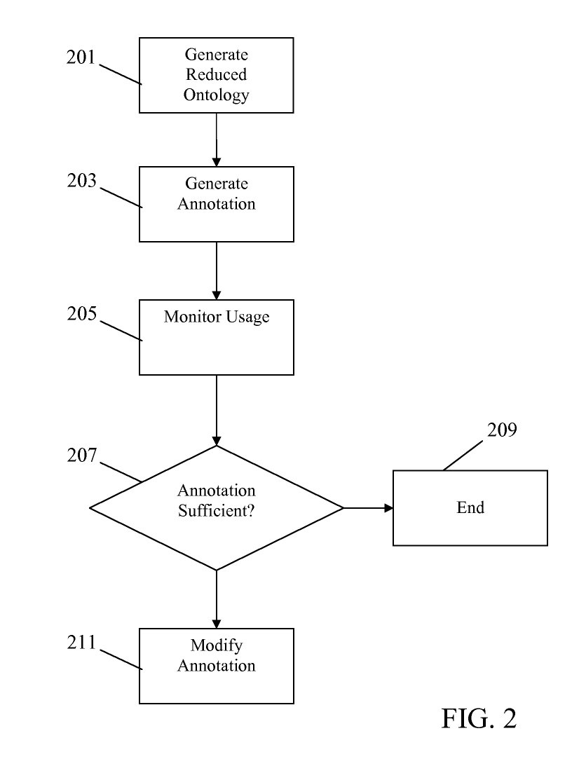

FIG. 2 illustrates a method in accordance with some embodiments of the invention.

The method initiates in step 201 wherein a reduced ontology is generated from a first ontology. The reduced ontology comprises a subset of concepts of the first ontology.

Step 201 is followed by step 203 wherein first annotation data is determined for the content item by content analysis based on the reduced ontology.

Step 203 is followed by step 205 wherein usage of the first annotation data is monitored.

Step 205 is followed by step 207 wherein it is determined if the usage of the first annotation data meets a first criterion.

If so, the program terminates in step 209.

Otherwise, the method continues in step 211 wherein a second ontology is generated from the first ontology and the first annotation data is modified in response to a content analysis based on the second ontology.

In some embodiments, the method may iterate the process of modifying the first annotation data. Specifically, the method may return to step 205 following step 211.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for content item annotation, the apparatus comprising:
means for generating a reduced ontology from a first ontology, the reduced ontology comprising a subset of concepts of the first ontology;
means for determining first annotation data for the content item by content analysis based on the reduced ontology;
monitoring means for monitoring usage of the first annotation data;
criterion means for determining if the usage of the first annotation data meets a first criterion;
modifying means for, if the usage of the first annotation data does not meet the first criterion, generating a second ontology from the first ontology and modifying the first annotation data in response to a content analysis based on the second ontology.

2. The apparatus of claim 1 wherein the means for generating the reduced ontology is furthermore arranged to generate first content description data for the subset of concepts, and wherein the content analysis is in response to the first content description data.

3. The apparatus of claim 2 wherein the modifying means is arranged to generate second content description data for concepts of the second ontology and wherein the content analysis based on the second ontology is further in response to the second content description data.

4. The apparatus of claim 1 further comprising:
means for storing a plurality of annotated content items;
means for searching the plurality of content items in response to search data based on the first ontology;
means for identifying the first content item in response to a match between the search data and the first annotation data.

5. The apparatus of claim 4 wherein the first criterion includes an evaluation of a number of times the first content item is identified in response to a search.

6. The apparatus of claim 5 wherein the first criterion includes an evaluation of a number of other content items identified by a search identifying the first content item.

7. The apparatus of the claim 4 wherein the means for identifying the first content item is arranged to generate a match indication of how closely the first content item matches the search data; and the first criterion includes an evaluation of the match indication.

8. The apparatus of claim 4 further comprising means for presenting an indication of content items identified by the search to a user of the apparatus; means for receiving a user selection of at least one of the content items; and wherein the first criterion includes an evaluation of a number of times the first content item is selected by the user.

9. The apparatus of claims 4 further comprising means for determining an annotation indication of a level of annotation for the plurality of content items, and wherein the first criterion includes an evaluation of the annotation indication.

10. The apparatus of claim 1 further comprising means for selecting concepts from the subset of concepts of the reduced ontology in response to a user input.

11. The apparatus of claim 1 further comprising means for selecting concepts from the subset of concepts of the reduced ontology in response to a use frequency of concepts of the first ontology.

12. The apparatus of claim 1 wherein the reduced ontology is a single domain ontology and the second ontology is a combined ontology comprising a plurality of different domain ontologies.

13. The apparatus of claim 1 wherein the second ontology comprises more concepts than the reduced ontology.

14. The apparatus of claim 1 wherein the monitoring means, the criterion means and the modifying means are arranged to iteratively modify the second ontology and the first annotation data in response to a content analysis based on the second ontology if the use behaviour does not meet the first criterion.

15. The apparatus of claim 1 arranged to generate the first annotation data without any user input.

16. The apparatus of claim 1 wherein the first annotation data comprises a semantic annotation.

16. The apparatus of claim 1 wherein the first content item is a visual content item.

17. A method of content item annotation, the method comprising:
generating a reduced ontology from a first ontology, the reduced ontology comprising a subset of concepts of the first ontology;
determining first annotation data for the content item by content analysis based on the reduced ontology;
monitoring usage of the first annotation data;
determining if the usage of the first annotation data meets a first criterion; and
if the usage of the first annotation data does not meet the first criterion, generating a second ontology from the first ontology and modifying the first annotation data in response to a content analysis based on the second ontology.
